(19) United States
(12) Patent Application Publication
(10) Pub. No.: US 2014/0158852 A1
(43) Pub. Date: Jun. 12, 2014

(54) Beverage Holder Assembly

(71) Applicant: Lear Corporation, Southfield, MI (US)

(72) Inventor: Christer Andersson, Trollhattan (SE)

(21) Appl. No.: 13/943,318

(22) Filed: Jul. 16, 2013

Related U.S. Application Data
(60) Provisional application No. 61/672,579, filed on Jul. 17, 2012.

(51) Int. Cl. B60N 3/10

(52) U.S. Cl. CPC B60N 3/102
USPC 248/346.03

(57) ABSTRACT

A beverage holder assembly including a base having a recess formed therein. The recess defines a side wall and a beverage insertion axis. A plurality of flexible supports extends from the side wall and extend radially inwardly towards the beverage insertion axis. Each support includes a planar surface extending from the side wall and oriented at an angle of between 0 to 30 degrees relative to the beverage insertion axis.

### CROSS-REFERENCE TO RELATED APPLICATIONS

This application claims the benefit of U.S. Provisional Application No. 61/672,579, filed Jul. 17, 2012, the disclosure of which is incorporated herein by reference.

### BACKGROUND OF THE INVENTION

This invention relates in general to vehicle interior components and in particular to beverage containers mounted therein.

It is becoming common for various components of a vehicle interior to include cupholders or beverage holders for securing various items, such as a beverage container. It is known to integrate beverage holders into portions of vehicle seats. For example, a beverage holder may be incorporated into an armrest assembly of a rear bench style seat, wherein the armrest assembly is movable between a raised and a lowered position. Such conventional beverage holders often utilize a plastic base which is mounted or insert molded into the foam portion of the armrest.

Conventionally known beverage holders mounted in an armrest or mounted elsewhere in the vehicle interior have many various configurations. Some are simply a cylindrical recess formed in a component for supporting a beverage container disposed therein. It is also known, such as from U.S. Pat. No. 7,354,086 to include a flat circular elastomeric member having a hole formed therethrough with radial slits formed in edges of the hole. The elastomeric member is mounted in a horizontal plane and includes portions which are deflected downwardly to provide support for the beverage container. It can often times be difficult to deflect these portions when inserting the beverage container. Additionally, the portions may not provide adequate support for the beverage container, especially relatively tall containers.

It is also known to provide recesses formed from an elastomeric material having recesses including resilient arcuate bulges formed in the side walls thereof, such as is disclosed in U.S. Pat. No. 6,050,468. Depending on the size of the beverage container, these may also be difficult to insert the beverage containers as well as often times only providing lateral support near the bottom portion of the beverage container.

### SUMMARY OF THE INVENTION

This invention relates to beverage holders, and in particular, to a beverage holder assembly including a base having a recess formed therein. The recess defines a side wall and a beverage insertion axis. A plurality of flexible supports extends from the side wall and extends radially inwardly towards the beverage insertion axis. Each support includes a planar surface extending from the side wall and oriented at an angle of between 0 to 30 degrees relative to the beverage insertion axis.

Another aspect of the invention relates to a beverage holder assembly including a base having a recess formed therein. The recess defines a side wall and a vertical axis. A plurality of flexible planar supports extends in a cantilevered orientation from the side wall towards the beverage insertion axis. Each support is mounted in a non-horizontal orientation relative to the vertical axis.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic perspective view of a bench style seat having a pivoting armrest assembly with a beverage holder assembly mounted therein.

FIG. 2 is a perspective view of the armrest assembly of FIG. 1.

FIG. 3 is a perspective view of the armrest assembly of FIG. 1, wherein the beverage holder assembly is supporting cylindrical beverage cans.

FIG. 4 is a top plan view of one of the recesses of the beverage holder assembly.

FIG. 5 is a top plan view of the recess of FIG. 4, wherein a beverage can is supported therein.

FIG. 6 a schematic partial cross-sectional view of the recess taken along lines 6-6 of FIG. 4.

FIG. 7 is an exploded perspective view of an alternate embodiment of a beverage holder assembly including a bezel tray and a bottom mold.

FIG. 8 is a bottom perspective view of the bezel tray of FIG. 7.

FIG. 9 is a partial cross-sectional view of the bottom mold taken along lines 9-9 in FIG. 7.

### DETAILED DESCRIPTION OF THE PREFERRED EMBODIMENTS

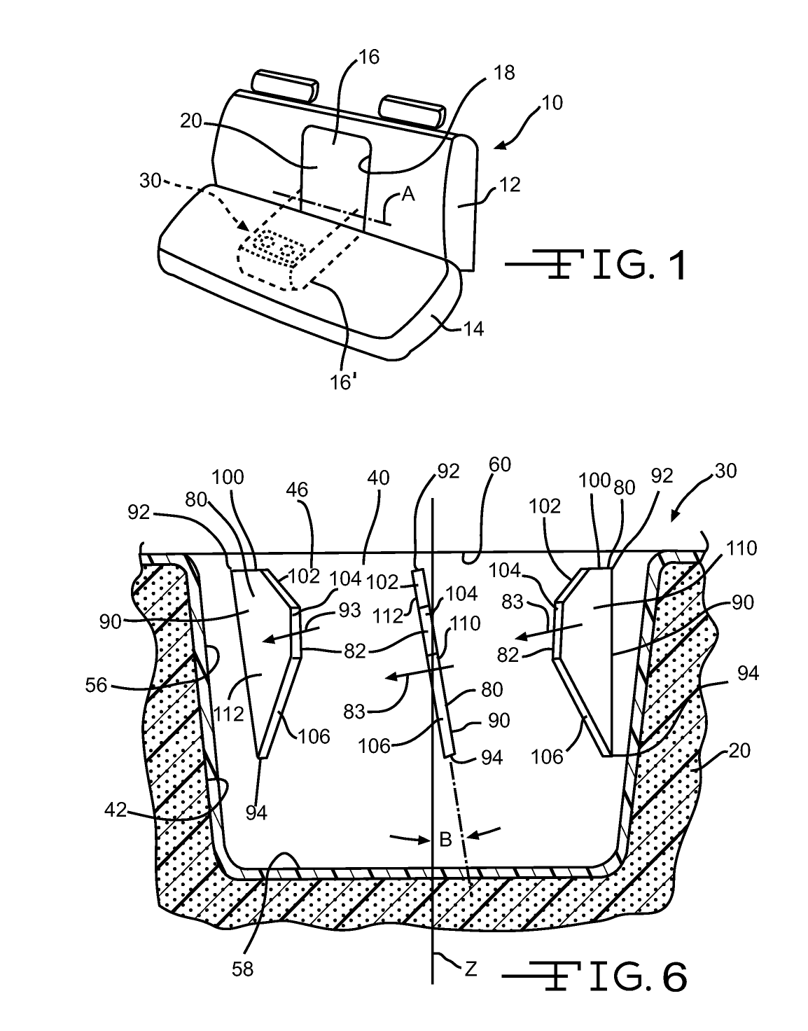

Referring now to the drawings, there is illustrated in FIG. 1 vehicle seat assembly 10. The seat assembly 10 may be in the form of a bench style seat such as for use as a rear seat of a sedan type vehicle. The seat assembly 10 includes a seat back 12 and a seat bottom 14. The seat back 12 may be fixed relative to the seat bottom 14 or may be pivotally mounted with respect to the seat bottom 14. The seat assembly 10 further includes an armrest assembly, indicated generally at 16. The armrest assembly 16 is movable between a storage upright position located within a recess 18 of the seat assembly 10, as shown in solid lines 16 in FIG. 1. The armrest assembly 16 is pivotally mounted relative to the seat back 12 such that the armrest assembly 16 pivots about an axis A, and can be moved to a lowered or use position as indicated by the broken lines 16′. The armrest assembly 16 may be mounted in the recess 18 such that a surface 20 of the armrest assembly 16 defines a seating surface (against an occupant's back) for the seat back 12 of the seat assembly 10. When in the lowered or use position, the armrest assembly 16 may be used as an armrest for passengers sitting on either side of the armrest assembly 16.

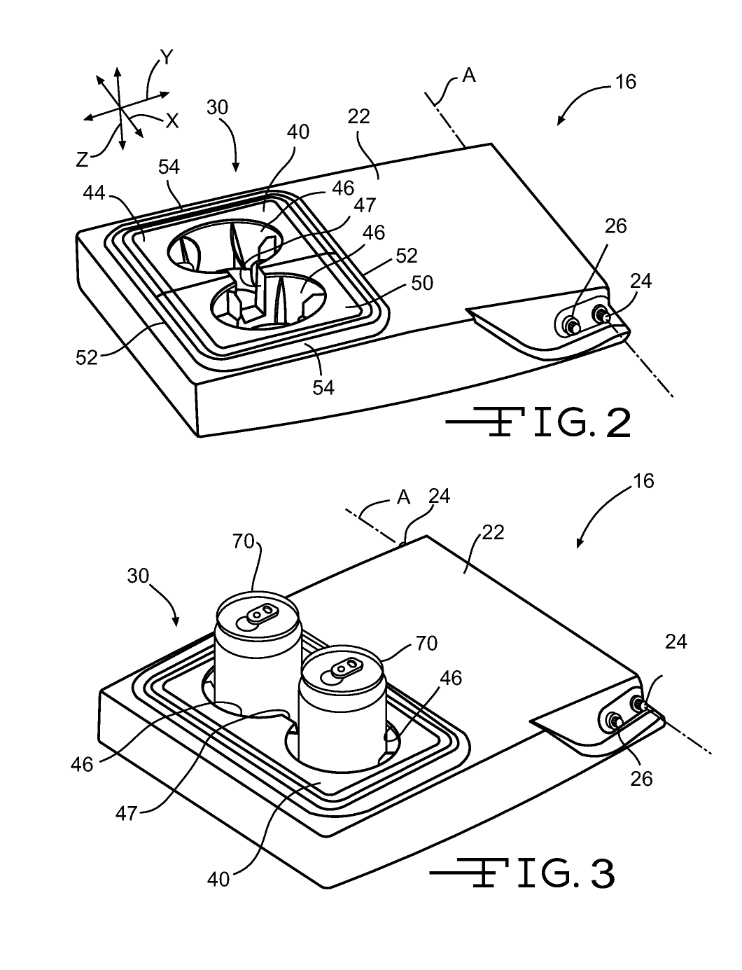

As will be discussed in detail below, the armrest assembly 16 generally includes a body 22 and a cup-holder or beverage holder assembly 30 mounted in a front portion of the body 30. The armrest assembly 16 may include an internal framework assembly (not shown) which supports the body 22. For example, the framework assembly may include metallic rods or rigid plastic molded pieces for supporting flexible foam defining the body 22. The framework assembly 112 may include structures positioned at the perimeter of the armrest assembly 16 to provide support and rigidity to the armrest assembly 16. The body 22 may cover the framework assembly as well as portions of the beverage holder assembly 30. The body 22 may include foam material or other padding material. The body 22 may also be covered with an upholstery cover material for a more pleasant aesthetic appearance. In one example, the beverage holder assembly 30 and the framework assembly may be insert molded into a foam material forming the body 22. The framework assembly may include a pivot rod 24 disposed along the axis A. Ends of the pivot rod 24 may extend laterally outwardly from a rear portion of the body 22, as shown in FIGS. 2 and 3. The ends of the pivot rod 24 may be disposed within pivot holes (not shown) within the recess 18 of the seat back 12 to provide the pivoting or hinged movement of the armrest assembly 16 relative to the seat back 12. The armrest assembly 16 may further include a detents or stops 26 to limit the angular motion of the armrest assembly 16 at its upright and lowered positions. For example, the stops 26 may be inserted into respective arcuate tracks or slots (not shown) formed in the recess 18 of the seat back 12 such that further movement of the armrest assembly 16 is prevented when the stops 26 abut against ends of the arcuate slots.

Although the beverage holder assembly 30 is shown mounted in an armrest assembly 16, it should be understood that the beverage holder may be mounted in any suitable area in the interior of the vehicle. For example, the assembly 10 may be mounted in a center console, an instrument panel, a trim panel, a seat assembly, or a fixed armrest. For purposes of explanation and orientation, the beverage holder assembly 30 and its components will be described relative to an X, Y, and Z axis system, as shown in FIG. 2, but it should be understood that the invention is not limited to such orientation. The Z axis may be described as being a generally vertical axis, such as for example, relative to the plane defined by the surface of the armrest assembly 16 in which the seat occupant rests their forearms. The X axis and the Y axis may lie in a generally horizontal plane and may be oriented laterally or longitudinally along the axis of the vehicle into which the assembly 10 is installed.

In the embodiment shown in FIGS. 1 through 6, the beverage holder assembly 16 includes an insert or base 40 which is disposed within a recess 42 (see FIG. 6) formed in the body 20 of the armrest assembly 16. The base 40 is preferably made of a relatively rigid material, such as plastic, but may also be made of a flexible material, such as rubber. The base 12 includes a generally flat upper bezel portion 44 and a pair of recesses 46 formed therein. The bezel portion 44 may be rectangular in shape and includes an upper surface 50 having a pair of side edges 52 and a pair of end edges 54. The edges 52 and 54, or any other part of the base 40, may include mounting features (not shown) for connecting to the body 22. For example, the mounting features may include integrally formed resilient clips (not shown) that snap into engagement with corresponding mating features (not shown) of the body 22.

As best shown in FIG. 6, each recess 46 may be generally cylindrical in form and may include a slight taper suitable for molding purposes. The recesses 46 define a generally cylindrical wall 56, a bottom floor 58, and an upper opening 60. The cylindrical wall 56 defines a side wall. The generally cylindrical recesses 46 extend along the generally vertical Z-axis when the armrest assembly 16 is in its lowered position. The recesses 46 may receive a beverage container or other item which the user wishes to support within the assembly 10. For example, the recesses 46 may be circular in shape to accommodate a cylindrical can 70, as shown in FIG. 3. Of course, the recesses 46 may be configured to hold and support any other suitable items such as a mobile device, a bottle, cup or other container. The recesses 46 may also be connected together by a trough 47 which communicates with the cavities defined by recesses 46. The recesses 46 may end at the generally horizontal bottom floor 58 for supporting the bottom of a beverage container or item placed in the recesses 46. Of course, the beverage holder assembly 30 may be formed with a single recess 46 or any other suitable number of recesses.

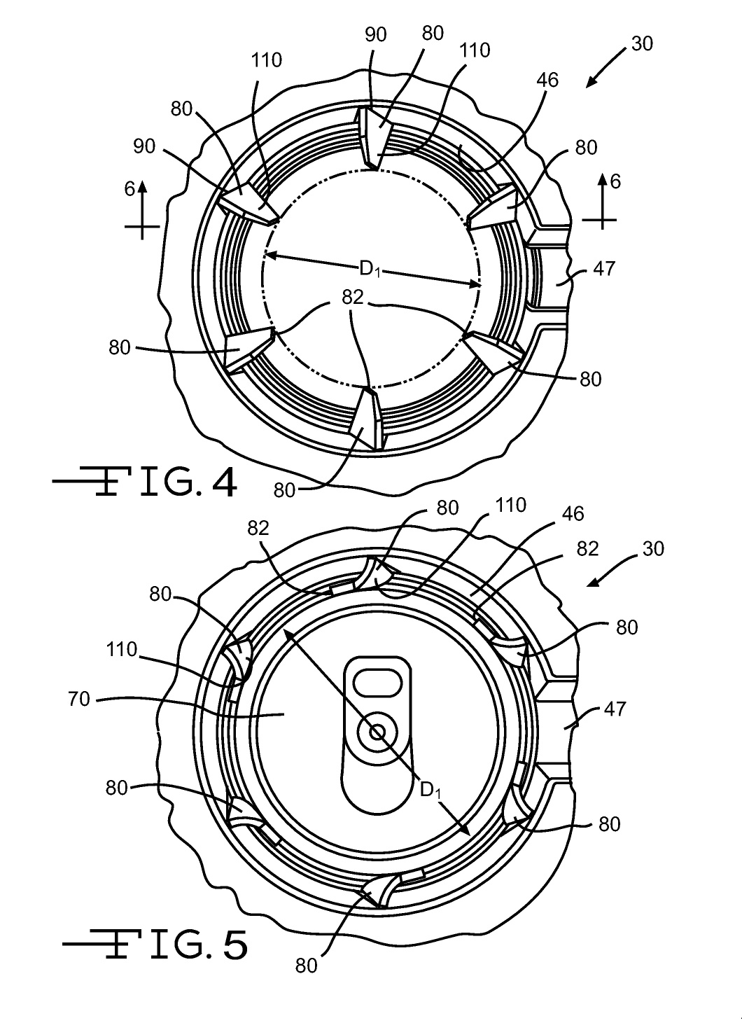

The beverage holder assembly 30 further includes a plurality of supports 80 mounted in each of the recesses 46. The supports 80 provide support for the beverage container or item placed within the recesses 46. The supports 80 provide for lateral and longitudinal support, e.g., along a general horizontal plane defined by the X and Y axes. The supports 80 are spaced from one another around the circumference of the wall 56. As best shown in FIGS. 4 and 5, the illustrated embodiment shows six supports 80 in each of the recesses 46. Of course, any number of supports 80 may be used. The supports 80 extend radially inwardly from the cylindrical wall 56 towards the Z-axis or center of the recesses 46. The Z-axis also defines a beverage insertion axis or direction in which the beverage container 70 is inserted into the respective recess 46. The supports 80 are generally mounted on the side wall or cylindrical wall 56 in a cantilevered fashion. The supports 80 are preferably made of a flexible material, such as rubber or other elastomeric material. The supports 80 may have a relative planar or flat shape such that they may be flexed, as shown in FIG. 5, when a beverage container 70 of sufficient diameter is disposed in the recess. The supports 80 shown in FIGS. 4 and 5 are identical in shape to help center the beverage container 70 within the recess 46 when they are flexed. This configuration also assists in providing equal support around the perimeter of the beverage container 70. However, it should be understood that the supports may be configured differently. For example, the beverage holder assembly 30 may include an even number of supports 80 which alternate in shape and size to accommodate differently sized items while still centering the item placed in the recess 46 as well as providing equal support around the perimeter of the item.

The supports 80 may be formed from generally flat plates that are supported on one edge of the cylindrical walls 30 and extend inwardly into the cavities of recesses 46. The supports 80 can have any suitable shape, such as rectangular, curved, or otherwise shaped. It should be understood that the supports 40 are not limited to the exact shape as shown and described herein. The supports 40 may be made of a relatively flexible material, such as rubber or other elastomeric material. The supports 80 flex to accommodate a beverage container or item placed in the respective recess 46 which is larger than a diameter D₁ defined by tips or free ends 82 of the plurality of supports 80. This is illustrated in FIGS. 3 and 5 in which a beverage container 70 is placed therein having a diameter D₂ larger than the diameter D₁. Insertion of the beverage container 70 causes the supports 80 to flex, as shown in FIG. 5, to accommodate the beverage container 70 inserted into the recess 46.

As shown in FIG. 5, all of the supports 80 are bent or flexed in the same direction, counter-clockwise. This is accomplished by the supports 80 being attached and configured like blades of a turbine engine such that they are not oriented straight in a vertical plane but are slanted relative to the Z axis. For example, as shown in FIG. 6, the supports 80 are formed from a relatively flat member attached along an edge 90. The attachment edges 90 are positioned at an angle B relative to the generally vertical Z axis. The angle B may be slight, such as between 0-5 or 0-15 degrees, or may be larger such as between 15 and 30 degrees. The attachment edges 90 include upper corners 92 and lower corners 94. As shown in FIG. 6, the lower corners 94 are offset in the horizontal direction (X and Y axes) from the upper corners 92. All of the supports 80 may be similarly oriented about the circumference of the wall 56. When a beverage or item having a diameter greater than D₁ is disposed downwardly into the respective recess 46, the slanted orientation of the supports 40 causes the free ends 82 of the supports 80 to flex in a direction as indicated by the arrows 83 in FIG. 6. The slanted orientation of the supports 40 provides ease of inserting the beverage or item downwardly into the recess 46. The supports 80 may be sufficiently flexible enough to bend at about right angles from a radial direction relative to the Z axis, as is shown in FIG. 5. The supports 80 may extend inwardly towards the Z axis at right angles relative to the attachment point at the wall 30.

In an alternate embodiment, the supports 80 may be oriented such that they are not slanted but are oriented generally in a vertical plane, i.e., angle B is about zero. The slanted or vertical orientation of the supports 80 provide greater stability over conventional beverage holders which have a plurality of horizontally extending rubber supports. This greater stability or support is provided in part from a greater contact area in the vertical direction along the height of the beverage can, bottle, or item, thereby providing better lateral support. This is especially useful for relatively tall beverages compared to the height of the recesses 46. The illustrated embodiment having the slanted supports 80 has an added advantage of making the insertion of the beverage bottle, can, or item easier due to the wedge or cam shape orientation of the engagement surface of the supports 80.

Although the supports 80 are described and shown as relatively flat plates, they may be curved or have a non-planar shape. The supports 80 may be separate pieces that are individually attached to the walls 56. The supports 80 may be attached by a suitable manner. For example, the supports 80 may extend through a slot formed in the wall 56 and include a flange or enlarged portion to prevent the support 80 from extending all the way through the slot. The flange may be located on the other side of the wall 56 opposite the recess 46. The supports 80 can be adhered to the wall or can include features which mechanically attach the supports 80 to the wall 56. Alternatively, the supports 80 may be insert molded into the base 40, or the supports 80 may be formed by a two shot molding process such that a first material forms the base 40 and a second material forms the supports 80.

The supports 80 can have any suitable shape which provides adequate support of the beverage or item placed in the respective recess 46. As best shown in FIG. 6, the supports 80 include an upper generally horizontal edge 100 extending from the upper corner 92 toward the Z axis. A slanted or chamfered edge 102 extends between the end of the horizontal edge 100 and a generally vertical edge 104. The bottom portion of the supports 80 includes a bottom slanted edge 106 between the vertical edge 104 and the bottom corner 94. The flat or planar supports 80 define an engagement surface 110 and an opposing surface 112. When the beverage container 70 is inserted into the recess 46, the bottom of the beverage container 70 will contact the horizontal edge 100 of the chamfered edge depending on the diameter D₂ of the beverage container 70. Further movement of the beverage container 70 in a downward direction, assuming the D₂ is greater than D₁, will cause the supports 80 to flex inwardly as shown in FIG. 5. The bottom of the beverage container 70 will slide downward along the engagement surface 110. The size and length of the bottom slanted edge 106 can be sized to provide sufficient lateral support while still maintaining a relatively low frictional force to force the beverage container 70 downwardly through the supports 80 as they are flexed. The chamfered edge 102 functions as a guide when the beverage container 70 is advanced downwardly such that the beverage will be somewhat automatically centered when pressing the beverage downwardly. The elastomeric material of the supports 80 may be selected to provide a desired amount of frictional force.

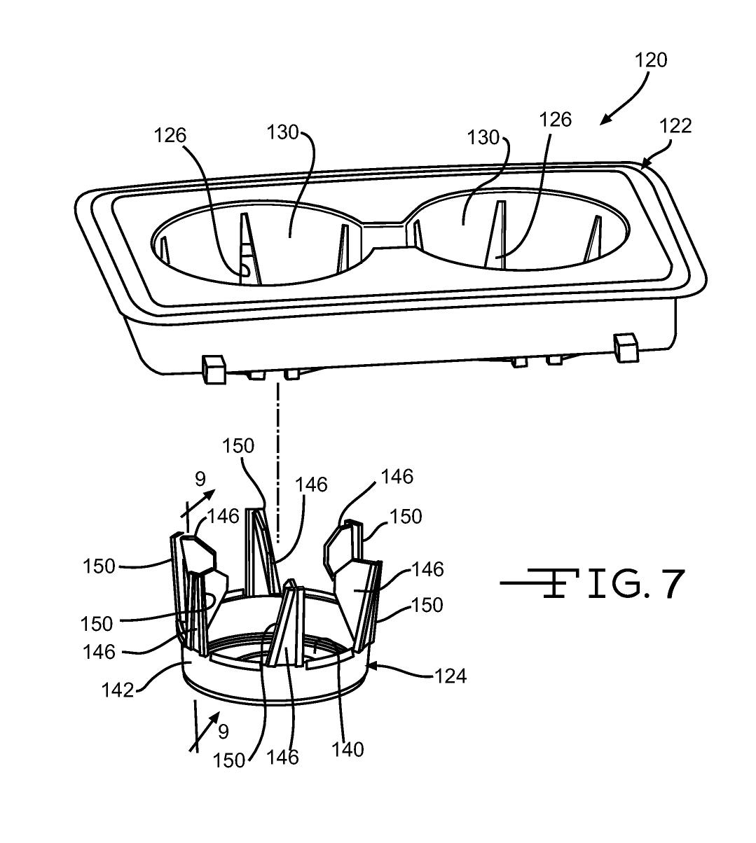

There is illustrated in FIGS. 7 through 9 an alternate embodiment of a beverage holder assembly, indicated generally 120. The beverage holder assembly 120 is similar in function as the beverage holder assembly 16 described above. The beverage holder assembly 120 includes a bezel 122 preferably made of a rigid material, such as plastic. Instead of individual supports 80, the beverage holder assembly 120 includes a pair of bottom mold assemblies 124 (one shown in FIG. 7) which incorporates supports, as will be discussed below. Each bottom mold assembly 120 may be formed as a single molded part. The bezel 122 defines an upper portion of the beverage holder assembly 120 while the two bottom mold assemblies 124 define the bottom portion of the beverage holder assembly 120.

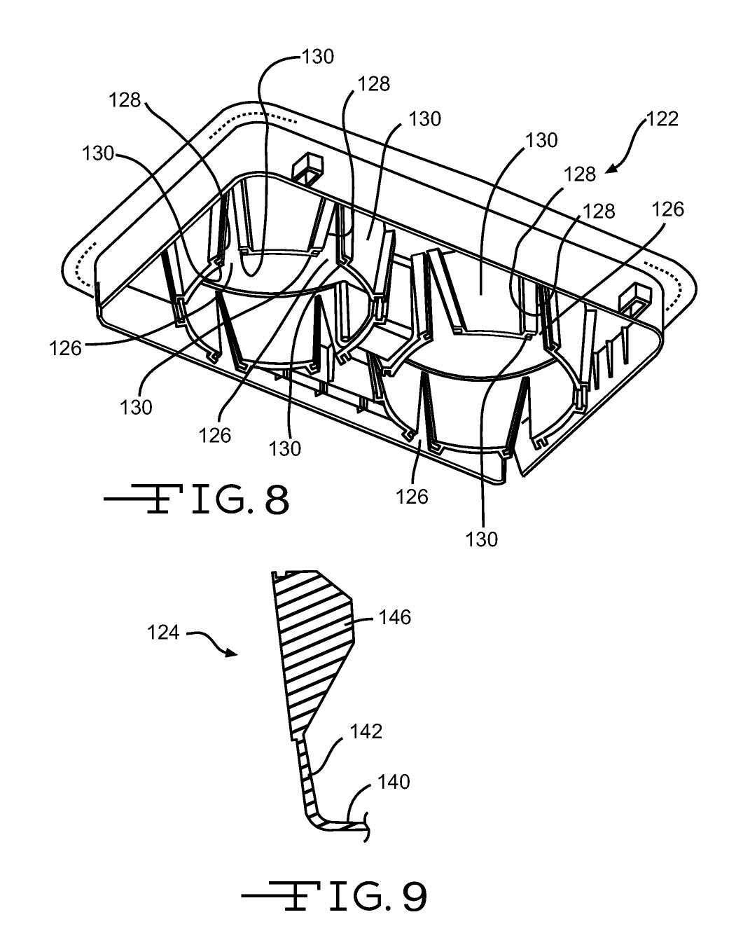

The bezel 122 includes a pair of tapered cylindrical recesses 130 formed therein defining side walls 132. As best shown in FIG. 8, each side wall has six angled slots 126 formed therein. Each slot 126 defines a pair of edges 128 having opposing slots 130 formed therein.

Each of the bottom hold assemblies 124 is preferably formed from a single molded part and made of an elastomeric material. Each of the bottom mold assemblies 124 includes a generally circular flat bottom floor portion 140. A generally cylindrical wall 142 extends upwardly from the perimeter of the bottom floor portion 140. Each bottom mold assembly 124 further includes six supports 146 extending upwardly from the upper portion of the wall 142. Each support 146 includes a flange 150 corresponding in shape to the slots 130 of the bezel 122.

For assembly of the beverage holder assembly 120, the flanges 150 of the supports 146 are slid upwardly into the slots 130 of the bezel 122. The bottom mold assemblies 124 can be attached to the bezel 122 by any suitable method such as by adhesive, welding, or mechanical fastening. The bottom mold assemblies 124 and/or the bezel 122 may include integrally formed features, such as snap fit connectors, to enable quick assembly. As shown in FIG. 9, the supports 146 are similar in function and structure as the supports 80 described above with respect to the beverage holder assembly 16.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A beverage holder assembly comprising:
a base having a recess formed therein, wherein the recess defines a side wall and a beverage insertion axis;
a plurality of flexible supports extends from the side wall and extends radially inwardly towards the beverage insertion axis, wherein each support includes a planar surface extending from the side wall and oriented at an angle of between 0 to 30 degrees relative to the beverage insertion axis.

2. The assembly of claim 1, wherein each support includes a planar surface extending from the side wall and oriented at an angle of between 5 to 30 degrees.

3. The assembly of claim 1, wherein each of the supports include a flexible flat plate.

4. The assembly of claim 1, wherein each support is capable of flexing such that the surfaces are at right angle relative to the beverage insertion axis.

5. The assembly of claim 1, wherein each of the supports are made of an elastomeric material.

6. The assembly of claim 1, wherein the base defines a bottom floor.

7. The assembly of claim 1, wherein each of the supports include a flange, and wherein the flanges are received within slots formed in the side wall of the base to secure the supports to the side wall.

8. The assembly of claim 1, wherein each of the supports are connected together in a single molded part.

9. The assembly of claim 8, wherein each of the supports include a flange, and wherein the flanges are received within slots formed in the side wall of the base to secure the supports to the side wall.

10. The assembly of claim 8, wherein the single molded part includes a cylindrical side wall and a bottom floor.

11. A beverage holder assembly comprising:
a base having a recess formed therein, wherein the recess defines a side wall and a vertical axis;
a plurality of flexible planar supports extends in a cantilevered orientation from the side wall towards the beverage insertion axis, wherein each support is mounted in a non-horizontal orientation relative to the vertical axis.

12. The assembly of claim 11, wherein each support includes a planar surface extending from the side wall and oriented at an angle of between 0 to 30 degrees.

13. The assembly of claim 11, wherein each of the supports include a flexible flat plate.

14. The assembly of claim 11, wherein each support is capable of flexing such that the surfaces are at right angle relative to the beverage insertion axis.

15. The assembly of claim 11, wherein each of the supports are made of an elastomeric material.

16. The assembly of claim 11, wherein the base defines a bottom floor.

17. The assembly of claim 11, wherein each of the supports include a flange, and wherein the flanges are received within slots formed in the side wall of the base to secure the supports to the side wall.

18. The assembly of claim 11, wherein each of the supports are connected together in a single molded part.

19. The assembly of claim 18, wherein each of the supports include a flange, and wherein the flanges are received within slots formed in the side wall of the base to secure the supports to the side wall.

20. The assembly of claim 18, wherein the single molded part includes a cylindrical side wall and a bottom floor.
